(19) United States
(12) Patent Application Publication
(10) Pub. No.: US 2018/0293013 A1
(43) Pub. Date: Oct. 11, 2018

(54) System and Method for Dynamically Allocating Storage Drives in a Storage Array

(71) Applicant: DELL PRODUCTS, LP, Round Rock, TX (US)

(72) Inventors: Amit Pratap Singh, Allahabad (IN); Sharath Rao, Mangalore (IN); Sandeep Agarwal, Bangalore (IN); Deepu Sreedhar M, Calicut (IN); Vivek Sundaresan, Bangalore (IN); Sasikumar Subramani, Bangalore (IN)

(21) Appl. No.: 15/480,960

(22) Filed: Apr. 6, 2017

(51) Int. Cl. G06F 3/06; G06F 11/20

(52) U.S. Cl. CPC G06F 3/0631; G06F 11/2094; G06F 3/0619; G06F 3/0664; G06F 2201/815; G06F 3/0653; G06F 3/0683; G06F 2201/805; G06F 3/0647

(57) ABSTRACT

A storage array includes a storage controller and a set of storage drives. The set of storage drives includes a virtual disk formed from a group of the storage drives and a ready storage drive. The storage controller is configured to add the ready storage drive to the virtual disk to increase the size of the virtual disk when a threshold percentage of data storage provided by the virtual disk is used for data storage. The storage controller is configured to monitor when a storage drive of the virtual disk enters a predictive fail state, and in response to replace the predictive fail storage drive with the ready storage drive. The storage controller is configured to monitor when a storage drive of the virtual disk fails, and in response to replace the failed storage drive with the ready storage drive.

### FIELD OF THE DISCLOSURE

This disclosure generally relates to information handling systems, and more particularly relates to allocating storage drives in a storage array.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

A storage array may include a storage controller and a set of storage drives. The set of storage drives includes a virtual disk formed from a group of the storage drives and a ready storage drive. The storage controller is configured to add the ready storage drive to the virtual disk to increase the size of the virtual disk when a threshold percentage of data storage provided by the virtual disk is used for data storage. The storage controller is configured to monitor when a storage drive of the virtual disk enters a predictive fail state, and in response to replace the predictive fail storage drive with the ready storage drive. The storage controller is configured to monitor when a storage drive of the virtual disk fails, and in response to replace the failed storage drive with the ready storage drive.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating a generalized information handling system according to an embodiment of the present disclosure;

FIG. 2 illustrates a storage array of storage drives according to an embodiment of the present disclosure;

FIG. 3 illustrates a storage array of storage drives according to an embodiment of the present disclosure; and

FIG. 4 illustrates a flowchart for allocating storage drives in a storage array according to an embodiment of the present disclosure.

The use of the same reference symbols in different drawings indicates similar or identical items.

### DETAILED DESCRIPTION

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

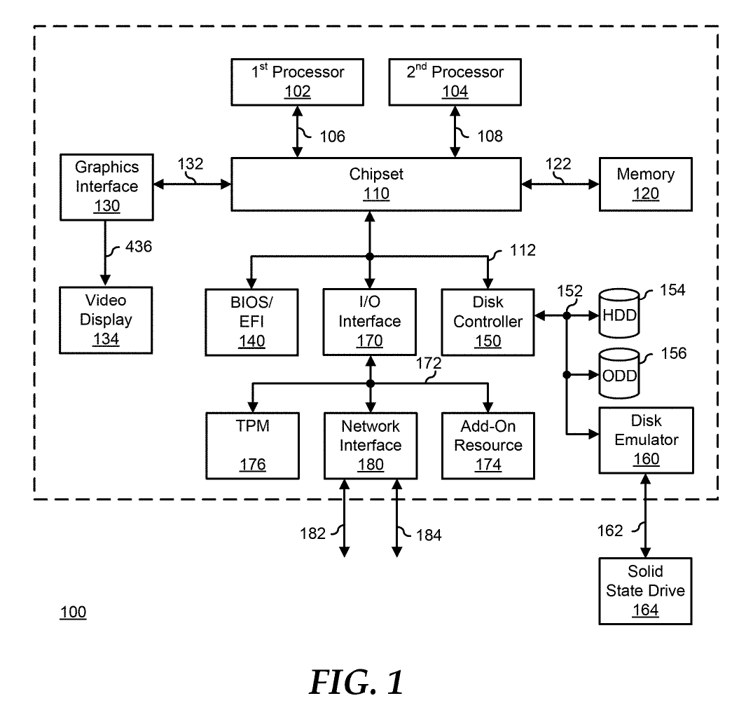

FIG. 1 illustrates a generalized embodiment of information handling system 100. For purpose of this disclosure information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smart phone, a tablet device or other consumer electronic device, storage array, a network server, a network storage device, a switch router or other network communication device, or any other suitable device and may vary in size, shape, performance, functionality, and price. Further, information handling system 100 can include processing resources for executing machine-executable code, such as a central processing unit (CPU), a programmable logic array (PLA), an embedded device such as a System-on-a-Chip (SoC), or other control logic hardware. Information handling system 100 can also include one or more computer-readable medium for storing machine-executable code, such as software or data. Additional components of information handling system 100 can include one or more storage devices that can store machine-executable code, one or more communications ports for communicating with external devices, and various input and output (I/O) devices, such as a keyboard, a mouse, and a video display. Information handling system 100 can also include one or more buses operable to transmit information between the various hardware components.

Information handling system 100 can include devices or modules that embody one or more of the devices or modules described above, and operates to perform one or more of the methods described above. Information handling system 100 includes a processors 102 and 104, a chipset 110, a memory 120, a graphics interface 130, include a basic input and output system/extensible firmware interface (BIOS/EFI) module 140, a disk controller 150, a disk emulator 160, an input/output (I/O) interface 170, and a network interface 180. Processor 102 is connected to chipset 110 via processor interface 106, and processor 104 is connected to the chipset via processor interface 108. Memory 120 is connected to chipset 110 via a memory bus 122. Graphics interface 130 is connected to chipset 110 via a graphics interface 132, and provides a video display output 136 to a video display 134. In a particular embodiment, information handling system 100 includes separate memories that are dedicated to each of processors 102 and 104 via separate memory interfaces. An example of memory 120 includes random access memory (RAM) such as static RAM (SRAM), dynamic RAM (DRAM), non-volatile RAM (NV-RAM), or the like, read only memory (ROM), another type of memory, or a combination thereof.

BIOS/EFI module 140, disk controller 150, and I/O interface 170 are connected to chipset 110 via an I/O channel 112. An example of I/O channel 112 includes a Peripheral Component Interconnect (PCI) interface, a PCI-Extended (PCI-X) interface, a high speed PCI-Express (PCIe) interface, another industry standard or proprietary communication interface, or a combination thereof. Chipset 110 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/EFI module 140 includes BIOS/EFI code operable to detect resources within information handling system 100, to provide drivers for the resources, initialize the resources, and access the resources. BIOS/EFI module 140 includes code that operates to detect resources within information handling system 100, to provide drivers for the resources, to initialize the resources, and to access the resources.

Disk controller 150 includes a disk interface 152 that connects the disc controller to a hard disk drive (HDD) 154, to an optical disk drive (ODD) 156, and to disk emulator 160. An example of disk interface 152 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 160 permits a solid-state drive 164 to be connected to information handling system 100 via an external interface 162. An example of external interface 162 includes a USB interface, an IEEE 1394 (Firewire) interface, a proprietary interface, or a combination thereof. Alternatively, solid-state drive 164 can be disposed within information handling system 100.

I/O interface 170 includes a peripheral interface 172 that connects the I/O interface to an add-on resource 174, to a TPM 176, and to network interface 180. Peripheral interface 172 can be the same type of interface as I/O channel 112, or can be a different type of interface. As such, I/O interface 170 extends the capacity of I/O channel 112 when peripheral interface 172 and the I/O channel are of the same type, and the I/O interface translates information from a format suitable to the I/O channel to a format suitable to the peripheral channel 172 when they are of a different type. Add-on resource 174 can include a data storage system, an additional graphics interface, a network interface card (NIC), a sound/video processing card, another add-on resource, or a combination thereof. Add-on resource 174 can be on a main circuit board, on separate circuit board or add-in card disposed within information handling system 100, a device that is external to the information handling system, or a combination thereof.

Network interface 180 represents a NIC disposed within information handling system 100, on a main circuit board of the information handling system, integrated onto another component such as chipset 110, in another suitable location, or a combination thereof. Network interface device 180 includes network channels 182 and 184 that provide interfaces to devices that are external to information handling system 100. In a particular embodiment, network channels 182 and 184 are of a different type than peripheral channel 172 and network interface 180 translates information from a format suitable to the peripheral channel to a format suitable to external devices. An example of network channels 182 and 184 includes InfiniBand channels, Fibre Channel channels, Gigabit Ethernet channels, proprietary channel architectures, or a combination thereof. Network channels 182 and 184 can be connected to external network resources (not illustrated). The network resource can include another information handling system, a data storage system, another network, a grid management system, another suitable resource, or a combination thereof.

An example of an information handling system is a storage array of storage drives providing data storage on the storage drives. A storage array may include a storage array chassis including a storage controller connected to the storage drives to provide control and configuration of the storage drives, and the storage array chassis may define a physical outline or footprint of the storage array and encapsulate the storage drives of the storage array. A storage drive stores data on a set of disks encapsulated by the physical volume of the storage drive.

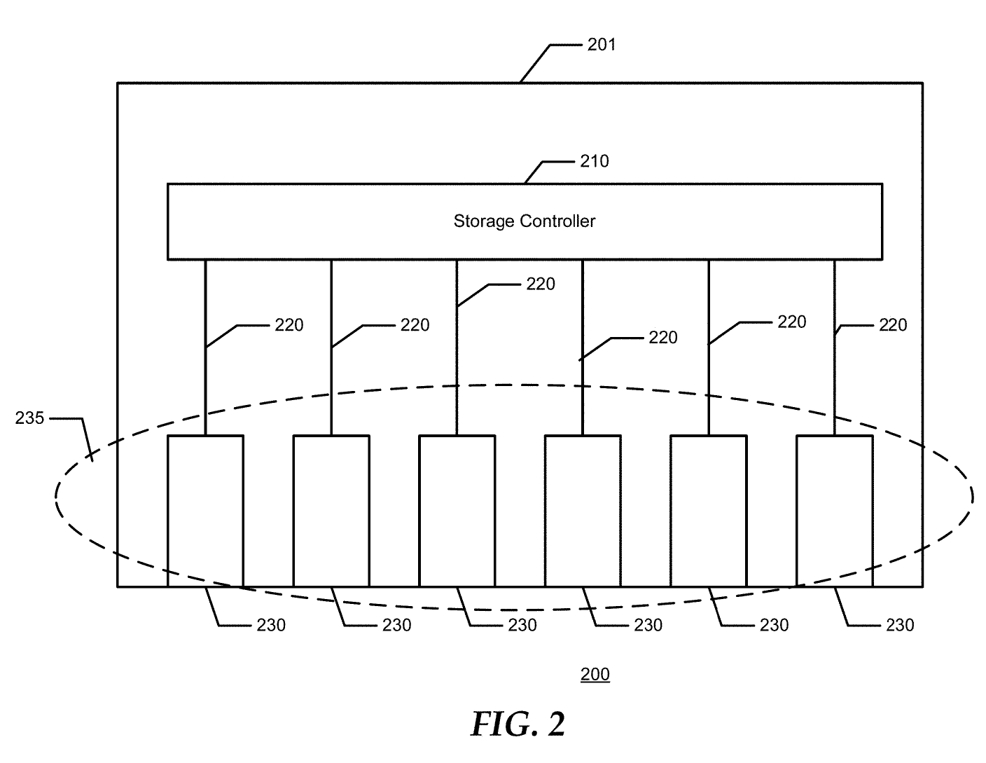

FIG. 2 shows an example storage array 200. Storage array 200 includes storage array chassis 201 defining the physical outline or footprint of storage array 200. Storage array 200 further includes storage controller 210 and storage drives 230 located interior to storage array chassis 201. Storage drives 230 may form a set 235 of storage drives 230. Individual storage drives 230 may be connected to storage controller 210 by respective connections 220 to allow for control and configuration of storage drives 230 by storage controller 210. Storage controller 210 may communicate with and monitor storage drives 230 over connections 220. Storage controller 210 may further configure and control storage drives 230 over connections 220.

Thus a storage array may include a set of storage drives; subsets or groupings of the storage drives may form virtual disks and thus a virtual disk may consist of or comprise storage drives providing storage capacity to the virtual disk. The storage controller may control amalgamating storage drives (and configure the same) to form virtual disks. An individual storage drive forming a virtual disk may fail or may be predicted to fail or be indicated to be predicted to fail.

One or more storage drives outside of virtual disks or yet to form virtual disks may have associated with the storage drive a corresponding flag, which may be located at the storage drive, or at the storage controller or storage controller memory, and may be a function in storage controller Basic Input/Output System (BIOS). The flag may indicate the storage drive is available for use or allocation by the storage controller. A storage drive with a flag indicating a ready state of the storage drive may be considered a ready storage drive which may be used, for example, to expand a virtual disk or substitute a storage drive forming a virtual disk. As such a flag indicating the readiness of a storage drive may be considered a ready flag.

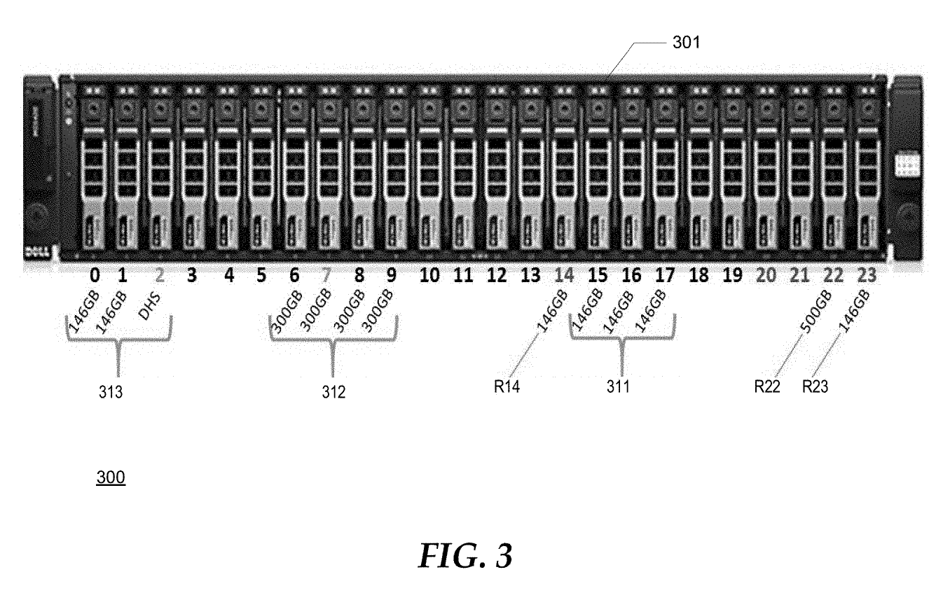

FIG. 3 shows an example storage array 300 in a front view. Storage array 300 stores individual storage drives 0-23, that is, 24 storage drives and includes storage array chassis 301 storing storage drives 0-23 in its physical footprint. Storage array 300 further includes a storage controller (not shown) interior to storage array chassis 301 and connected (not shown) to each of individual storage drives 0-23, for example, as shown in FIG. 2. The storage controller may communicate with and monitor storage drives 0-23, and may configure and control storage drives 0-23.

Individual storage drives 14 and 20-23 may be associated with, such as correspond to, respective ready flags indicating whether the storage drives are ready or available for use or allocation by the storage controller. The ready flag corresponding to storage drive 20 indicates that storage drive 20 is unavailable or not ready for use or allocation by the storage controller. Similarly, the ready flag corresponding to storage drive 21 indicates that storage drive 21 is unavailable or not ready for use or allocation by the storage controller.

In contrast, storage drives 14, 22 and 23 are available for use or allocation by the storage controller. Thus, the ready flag corresponding to storage drive 14 indicates that storage drive 14 is available or ready for use or allocation by the storage controller, the ready flag corresponding to storage drive 22 indicates that storage drive 22 is available or ready for use or allocation by the storage controller, and the ready flag corresponding to storage drive 23 indicates that storage drive 23 is available or ready for use or allocation by the storage controller, as shown by the R flag indications corresponding to the same. Storage drives 14 and 23 each have a size (or storage capacity) of 146 GB and storage drive 22 has a size of 500 GB. The storage controller may be aware of the size of each of storage drives 14, 22, and 23. The size of the individual storage drives may determine the use or allocation of the individual storage drives by the storage controller.

Storage drives 15, 16 and 17 are (logically) grouped into a redundant array of independent disks (RAID) array 311, for example, by the storage controller. Thus, storage drives 15, 16 and 17 may form a virtual disk 311, and this virtual disk 311 may have a RAID 5 configuration, as would be known by one of skill in the art. When a threshold percentage of the storage capacity of virtual disk 311 has been reached, for example, 75%, the storage controller may allocate a single storage drive of ready storage drives 14, 22 and 23 to virtual disk 311 to expand the storage capacity of virtual disk 311.

Since the storage drives 15, 16 and 17 forming virtual disk 311 each have a storage capacity of 146 GB, and since ready storage drive 14 also has a storage capacity of 146 GB and is proximal to storage drive 15 forming virtual disk 311, the storage controller may monitor virtual disk 311, and when the threshold percentage of the storage capacity of virtual disk 311 has been reached, may, for example, dynamically allocate ready storage drive 14 to virtual disk 311 to expand the storage capacity of virtual disk 311. When ready storage drive 14 is allocated, the storage controller may mark the corresponding ready flag for storage drive 14 as unready, allocated, or unavailable.

Storage drives 6-9 are (logically) grouped into a redundant array of independent disks (RAID) array 312, for example, by the storage controller. Thus, storage drives 6-9 may form a virtual disk 312, and this virtual disk 312 may have a RAID 6 configuration, as would be known by one of skill in the art. In virtual disk 312, storage drive 7 is in a state of predicative fail (predictive fail state), and either a number of errors indicting a predictive fail threshold has been passed or storage drive 7 is indicated to be predicted to fail, by, for example, a set fail flag. When storage drive 7 enters or is in a state of predicative fail, the storage controller may allocate a single storage drive of the ready storage drives, for example ready storage drives 22 and 23, to virtual disk 312 to replace storage drive 7 in virtual disk 312.

Because the storage drives 6-9 forming virtual disk 312 each have a storage capacity of 300 GB, and since ready storage drive 22 has a storage capacity of 500 GB and has the storage capacity to substitute for storage drive 7 in a one to one substitution of storage drives in virtual disk 312, the storage controller may monitor storage drives 6-9 of virtual disk 312, and when storage drive 7 enters a predictive fail state, and may, for example, dynamically allocate ready storage drive 22 to virtual disk 312 to replace storage drive 7 in virtual disk 312. The storage controller may recreate the data stored on storage drive 7 on storage drive 22 such that storage drive 22 stores the same data stored on storage drive 7.

Storage drives 0-2 are (logically) grouped into a redundant array of independent disks (RAID) array 313, for example, by the storage controller. Thus, storage drives 0-2 may form a virtual disk 313, and this virtual disk 313 may have a RAID 1 configuration, as would be known by one of skill in the art. In virtual disk 313, storage drive 2 has failed or may be inoperative or in a state of failure. When storage drive 2 fails, the storage controller may allocate a single storage drive of the ready storage drives to virtual disk 313 to replace storage drive 2 in virtual disk 313.

Since the storage drives 0-2 forming virtual disk 313 each have a storage capacity of 146 GB, and since ready storage drive 23 also has a storage capacity of 146 GB and thus has the storage capacity to substitute for storage drive 2 in a one to one substitution of storage drives in virtual disk 313, the storage controller may monitor storage drives 0-2 of virtual disk 313, and when storage drive 2 fails or becomes inoperable, the storage controller may, for example, dynamically allocate ready storage drive 23 to virtual disk 313 to replace storage drive 2 in virtual disk 313. The storage controller may recreate the data stored on storage drive 2 on storage drive 23 such that storage drive 23 stores the same data stored on storage drive 2.

Returning to unavailable storage drives 20 and 21: storage drive 20 may have been previously used or in use by the storage controller for RAID level migration and so storage drive 20 may be in use and its ready flag set to unavailable by the storage controller; storage drive 21 may be in use as a pass-through disk for temporary storage by the storage controller and so be unavailable for other use; consequently its ready flag may be set to unavailable by the storage controller.

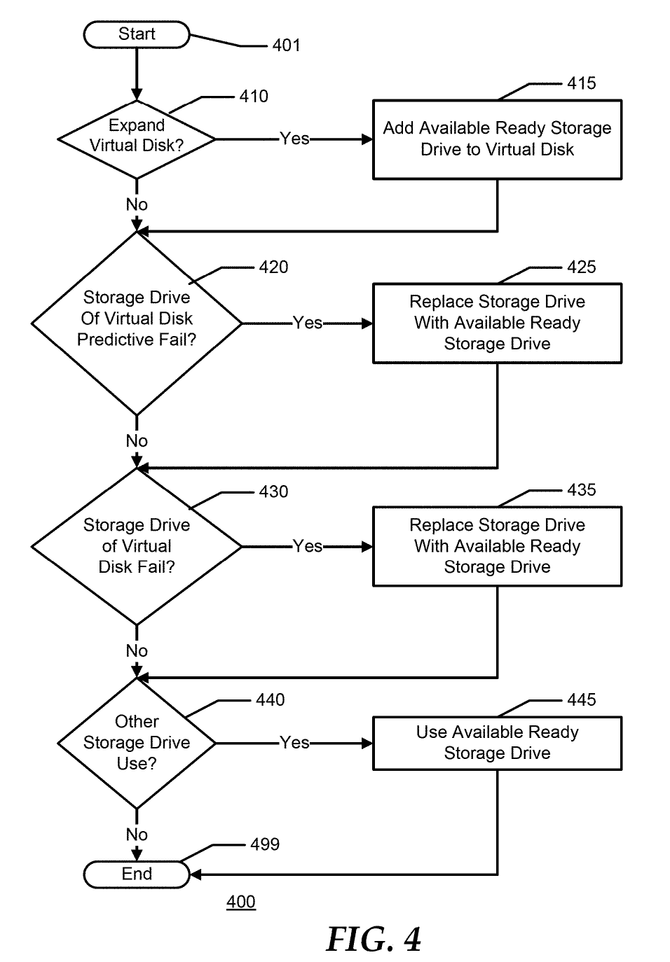

FIG. 4 shows an example method 400 of using ready storage drives as disclosed herein and may be performed by a storage controller. At 401, method 400 begins. At 410, it is determined by the storage controller whether a virtual disk should be expanded. For example, a threshold percentage of used data storage in the virtual disk may have been exceeded. If the virtual disk should be expanded, an available ready storage drive is added to the virtual disk at 415 to augment the virtual disk and increase available data storage in the virtual disk.

At 420, it is determined by the storage controller whether a storage drive of a virtual disk is in a predictive fail state, that is, predicted to fail. For example, a predictive fail flag corresponding to the storage drive may be set. If a storage drive of the virtual disk is in predictive fail, an available ready storage drive is added to the virtual disk at 425 to replace the predictive fail storage drive.

At 430, it is determined by the storage controller whether a storage drive of a virtual disk has failed or is inoperable. If a storage drive of the virtual disk has failed or is inoperable, an available ready storage drive is added to the virtual disk at 435 to replace the failed storage drive.

At 440, it is determined by the storage controller whether there is a further use for a storage drive and its storage, such as RAID level migration or a pass-through disk for temporary data storage. If there is a further use for a storage drive, at 445, the storage controller uses an available ready storage drive for the use. As can be understood from the above, the disclosure herein allows for dynamic allocation and use of storage drives in a storage array.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A storage array comprising:
a storage controller; and
a set of storage drives including a first virtual disk formed from a first group of the storage drives and a first ready storage drive, wherein the storage controller is configured to add the first ready storage drive to the first virtual disk to increase the size of the first virtual disk when a threshold percentage of data storage provided by the virtual disk is used for data storage.

2. The storage array of claim 1, further comprising a second virtual disk formed from a second group of the storage drives and a second ready storage drive, wherein the storage controller is configured to monitor when a second virtual disk storage drive of the second virtual disk enters a predictive fail state, and in response, replace the second virtual disk storage drive with the second ready storage drive in a one to one drive substitution.

3. The storage array of claim 1, further comprising a third virtual disk formed from a third group of the storage drives and a third ready storage drive, wherein the storage controller is configured to monitor when a third virtual disk storage drive of the third virtual disk fails, and in response, replace the third virtual disk storage drive with the third ready storage drive in a one to one drive substitution.

4. The storage array of claim 2, wherein the storage controller is configured to use a fourth ready storage drive of the storage drives for RAID level migration.

5. The storage array of claim 4, wherein a ready flag corresponds to the fourth ready storage drive.

6. The storage array of claim 3, wherein the storage controller is configured to use a fifth ready storage drive of the storage drives as a pass-through disk for temporary data storage.

7. The storage array of claim 6, wherein a ready flag corresponds to the fifth ready storage drive.

8. An information handling system comprising:
a storage controller; and
a set of storage drives including a first virtual disk formed from a first group of the storage drives and a first ready storage drive, wherein the storage controller is configured to monitor when a first virtual disk storage drive of the first virtual disk enters a predictive fail state, and in response to replace the first virtual disk storage drive with the first ready storage drive in a one to one drive substitution.

9. The information handling system of claim 8, further comprising a second virtual disk formed from a second group of the storage drives and a second ready storage drive, wherein the storage controller is configured to add the second ready storage drive to the second virtual disk to increase the size of the second virtual disk when a threshold percentage of data storage provided by the second virtual disk is used for data storage.

10. The information handling system of claim 8, further comprising a third virtual disk formed from a third group of the storage drives and a third ready storage drive, wherein the storage controller is configured to monitor when a third virtual disk storage drive of the third virtual disk fails, and in response, replace the third virtual disk storage drive with the third ready storage drive in a one to one drive substitution.

11. The information handling system of claim 9, wherein the storage controller is configured to use a fourth ready storage drive of the storage drives for RAID level migration.

12. The information handling system of claim 11, wherein a ready flag corresponds to the fourth ready storage drive.

13. The information handling system of claim 10, wherein the storage controller is configured to use a fifth ready storage drive of the storage drives as a pass-through disk for temporary data storage.

14. The information handling system of claim 13, wherein a ready flag corresponds to the fifth ready storage drive.

15. A method performed in a storage array including a first virtual disk and a first ready storage drive, the method comprising:
monitoring when a first virtual disk storage drive of the first virtual disk fails; and
when the first virtual disk storage drive fails, replacing the first virtual disk storage drive with the first ready storage drive in a one to one drive substitution.

16. The method of claim 15, wherein the storage array further includes a second virtual disk and a second ready storage drive, and the method further comprises:
monitoring when a threshold percentage of data storage provided by the second virtual disk is used for data storage; and
when a threshold percentage of data storage provided by the second virtual disk is used for data storage, adding the second ready storage drive to the second virtual disk to increase the size of the second virtual disk.

17. The method of claim 15, wherein the storage array further includes a third virtual disk and a third ready storage drive, and the method further comprises:
monitoring when a third virtual disk storage drive of the third virtual disk fails;
when the third virtual disk storage drive fails, replacing the third virtual disk storage drive with the third ready storage drive in a one to one drive substitution.

18. The method of claim 16, further comprising using a fourth ready storage drive of the storage array for RAID level migration.

19. The method of claim 17, further comprising using a fifth ready storage drive of the storage drives as a pass-through disk for temporary data storage.

20. The method of claim 19, wherein a ready flag is associated with the fifth ready storage drive.
